(19) United States
(12) Patent Application Publication
(10) Pub. No.: US 2020/0101910 A1
(43) Pub. Date: Apr. 2, 2020

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Tomoya KAWAGUCHI, Yokkaichi-shi (JP); Yuichi KIMOTO, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/497,641

(22) PCT Filed: Mar. 23, 2018
(86) PCT No.: PCT/JP2018/011710

§ 371 Date: Sep. 25, 2019

(30) Foreign Application Priority Data
Mar. 30, 2017 (JP) 2017-067434

(51) Int. Cl. B60R 16/02; H02G 3/04; H02G 3/32

(52) U.S. Cl. CPC B60R 16/0215; H02G 3/32; H02G 3/0406; H02G 3/0468

(57) ABSTRACT

A wire harness including a wire; an exterior material that has flexibility and covers the wire; a route regulator that has an axis extending along a wiring route of the wire, the axis of the route regulator not coinciding with a longitudinal axis of the exterior material, and the route regulator regulates the wiring route of the wire from outside the exterior material; a fixing member for fixing the route regulator to a vehicle; and at least one connector that connects the route regulator to the exterior material, the connector being provided separately from the exterior material and connecting the route regulator to the exterior material such that the route regulator does not come into direct contact with the exterior material.

### BACKGROUND

The present disclosure relates to a wire harness.

As disclosed in JP 2011-155763A a wire harness is known which includes a spine member for regulating a wiring route of a wire from outside a corrugated tube protecting the wire.

### SUMMARY

As described above, the route of a wire protected by a flexible exterior material, such as a corrugated tube, can be regulated by connecting the exterior material to a route-regulating member (spine member). Here, if the route of the wire includes a curved route, this route of the wire can be regulated by using a route-regulating member having a curved portion that conforms to the curved route, but there are cases where, for example, much time and effort are needed to form the curved portion of the route-regulating member.

An exemplary aspect of the disclosure provides a wire harness with which the overall shape of a route-regulating member for regulating the route of a wire covered by an exterior material can be simplified.

A wire harness that addresses the above-described problem is a wire harness including a wire, an exterior material that has flexibility and covers the wire, a route regulator that has an axis extending along a wiring route of the wire and the route regulator regulates the wiring route of the wire from outside the exterior material, a fixing member for fixing the route regulator to a vehicle, and at least one connector that connects the route regulator to the exterior material, wherein the wiring route of the wire includes a first straight route, a second straight route, and an intermediate route between the first straight route and the second straight route, the route regulator includes a first route regulator that regulates the first straight route and a second route regulator that regulates the second straight route, and the intermediate route includes a curved route that is not regulated by the route regulator.

With this configuration, since the intermediate route between the first straight route and the second straight route includes the curved route that is not regulated by the route regulator, the number of route regulators that have a curved portion can be reduced, or a route regulator that has a curved portion can be omitted.

It is preferable that, in the above-described wire harness, at least one route regulator of the first route regulator and the second route regulator is fixed to the vehicle using the fixing member at only one end of opposite ends of the at least one route regulator.

With this configuration, the time and effort needed for an operation of fixing the route regulator to the vehicle can be reduced.

It is preferable that, in the above-described wire harness, at least one route regulator of the first route regulator and the second route regulator is fixed to the vehicle at only a middle of the at least one route regulator.

With this configuration, the time and effort needed for an operation of fixing the route regulator to the vehicle can be reduced.

It is preferable that the above-described wire harness further includes an attachment for attaching, to the vehicle, a portion of the exterior material that is located at a position corresponding to the intermediate route.

With this configuration, the portion of the exterior material that is located at a position corresponding to the intermediate route can be favorably arranged.

It is preferable that, in the above-described wire harness, the at least one connector includes a plurality of connectors that connect the first route regulator to the exterior material and are not to be fixed to the vehicle and a plurality of connectors that connect the second route regulator to the exterior material and are not to be fixed to the vehicle.

With this configuration, displacement of the exterior material from the first straight route and the second straight route can be favorably suppressed.

According to the present disclosure, the overall shape of a route regulator that regulates the route of a wire covered by an exterior material can be simplified.

### BRIEF DESCRIPTION OF THE DRAWINGS

FIG. 1 is a schematic plan view showing a wire harness of an embodiment.

FIG. 2 is a schematic diagram illustrating a manner in which the wire harness is routed in a vehicle.

FIG. 3 is an exploded perspective view of a portion of the wire harness.

FIG. 4 is a partial perspective view of the wire harness.

FIG. 5 is an exploded perspective view of a portion of the wire harness.

### DETAILED DESCRIPTION OF EMBODIMENTS

Hereinafter, an embodiment of a wire harness will be described.

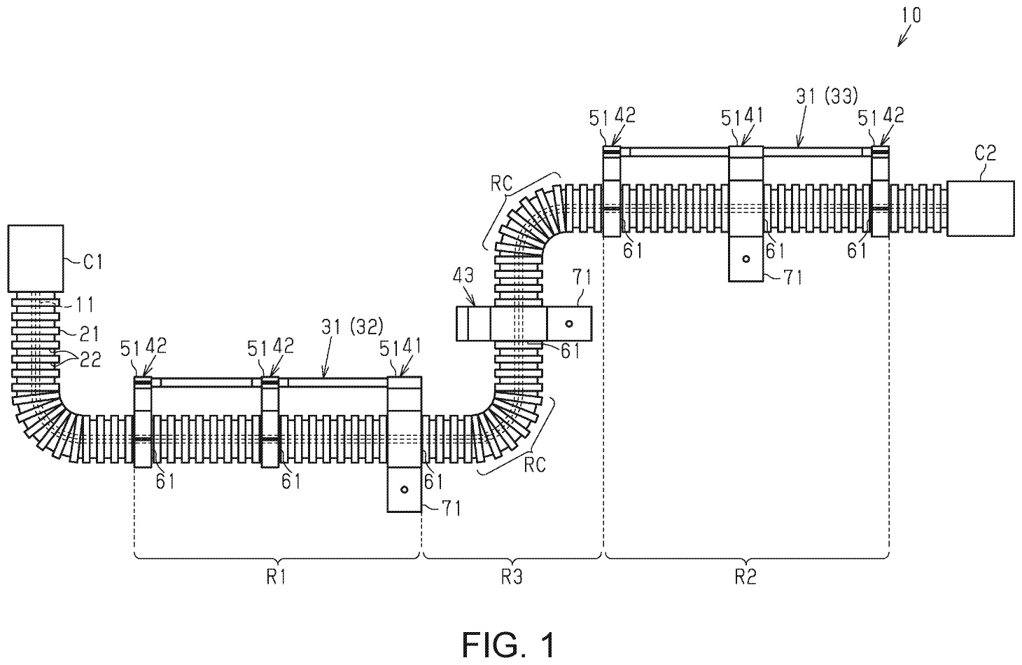

As shown in FIG. 1, a wire harness 10 includes a wire 11, an exterior material 21 that has flexibility and covers the wire 11, and a route-regulating member 31 (route regulator) that regulates a wiring route of the wire 11 from outside the exterior material 21. The wire harness 10 further includes a fixing member 41 for fixing the route-regulating member 31 to a vehicle and a connecting member 42 (connector) that connects the route-regulating member 31 to the exterior material 21.

The route-regulating member 31 is constituted by a first route-regulating member 32 that regulates a first straight route R1 and a second route-regulating member 33 that regulates a second straight route R2. An intermediate route R3 between the first straight route R1 and the second straight route R2 includes a curved route RC that is not regulated by the route-regulating member 31. As in the present embodiment, the intermediate route R3 may include a straight route, and may have a plurality of curved routes RC. The wire harness 10 further includes an attachment member 43 for attaching a portion of the exterior material 21 that is located at a position corresponding to the intermediate route R3 to the vehicle.

### Routing Manner

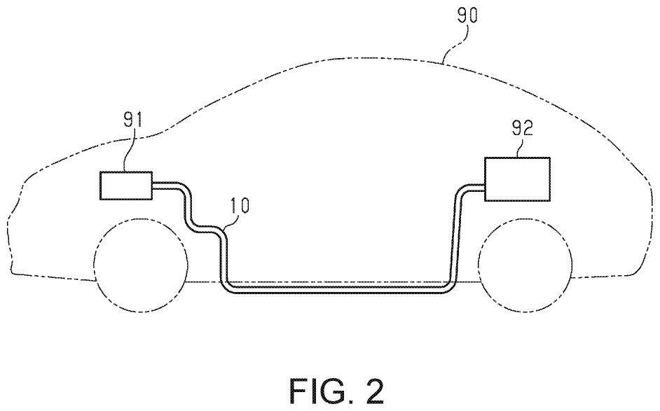

As shown in FIG. 2, the wire harness 10 is used to electrically connect a first device 91 and a second device 92 installed in a vehicle 90 to each other. The first device 91 is disposed on a front side of the vehicle 90. The second device 92 is disposed on a rear side of the vehicle 90. For example, one of the first device 91 and the second device 92 is a battery, and the other is an inverter. Note that it is also possible that one of the first device 91 and the second device 92 is a motor, and the other is an inverter. Examples of the vehicle 90 include an electric automobile, a hybrid automobile, a fuel-cell automobile, and the like. The wire harness 10 of the present embodiment is routed under the floor of the vehicle 90.

### Wire 11

The wire 11 has a core wire that has conductivity and an insulating coating that has an insulating property. The core wire is made of a conductive material such as copper or aluminum, for example. The core wire is composed of a single strand or a plurality of strands. As is well known, the insulating coating is made of an insulating material such as polyvinyl chloride and formed into a tubular shape.

As shown in FIG. 1, opposite end portions of the wire 11 are constituted by connector portions C1 and C2, respectively. The wire 11 is a high-voltage wire and is electrically connected to input/output terminals of the first device 91 and the second device 92 installed in the vehicle 90. A high-voltage wire for a vehicle has a rated voltage of greater than 30 V for AC, or greater than 60 V for DC. Note that a high-voltage wire for a vehicle has a rated voltage of 600 V or less for AC, or 750 V or less for DC.

The wire 11 may include a shielding material for shielding electromagnetic waves, or a shielding material for shielding electromagnetic waves may be separately disposed over the outer circumference of the wire 11. For example, a braided member that has a structure in which metal strands made of aluminum, stainless steel, copper, or an alloy thereof, etc. are braided into a mesh can be favorably used as the shielding material.

### Exterior Material 21

The exterior material 21 has flexibility and is thus configured to be able to deform to conform to the wiring route of the wire 11. The exterior material 21 covers the wire 11, thereby protecting the wire 11. The exterior material 21 is formed into a tubular shape that has a longitudinal axis, and the wire 11 is arranged in an inner space of the exterior material 21. In light of weight reduction, for example, it is preferable that the exterior material 21 is made of a resin material. Examples of the resin material include polyolefins, polyamides, polyesters, ABS resins, and the like. Specific examples of the exterior material 21 include a corrugated tube, a hard resin pipe, and the like.

As shown in FIG. 1, the exterior material 21 of the present embodiment is a corrugated tube and has a structure in which a plurality of annular recesses 22 are arranged in the longitudinal axis direction, and thus, is configured to be able to be easily curved or bent.

The exterior material 21 may also have a slit extending in the longitudinal axis direction. In the case where the exterior material 21 has a slit, the wire 11 can be arranged inside the exterior material 21 through the slit. Note that in the case where the exterior material 21 has a slit, the wire 11 can be prevented from protruding through the slit by winding a binding material, such as pressure-sensitive adhesive tape, around the outer circumference of the exterior material 21 as necessary.

### Route-Regulating Member 31

The route-regulating member 31 is arranged so as to partially regulate the route of the wire 11 from outside the exterior material 21. The first route-regulating member 32 has an axis extending along the first straight route R1 along which the wire 11 is routed. The second route-regulating member 33 has an axis extending along the second straight route R2 along which the wire 11 is routed. The route-regulating member 31 can be formed through cutting or the like in which, for example, a bar-shaped member is cut to a predetermined length. Alternatively, the route-regulating member 31 can also be molded in a mold.

The route-regulating member 31 is made of a material that is stiff enough to maintain the route of the wire 11 that is arranged inside the exterior material 21. A metal material is favorably used as the material of the route-regulating member 31. Examples of the metal material include aluminum, iron, copper, alloys of these metals, and the like. Note that the route-regulating member 31 may also be pipe-shaped.

### Fixing Member 41 and Connecting Member 42

Each of the fixing member 41 and the connecting member 42 has a support portion 51 that supports the route-regulating member 31 and an attachment portion 61 to which the exterior material 21 is attached. The fixing member 41 further has a fixed portion 71 that is to be fixed to the vehicle 90.

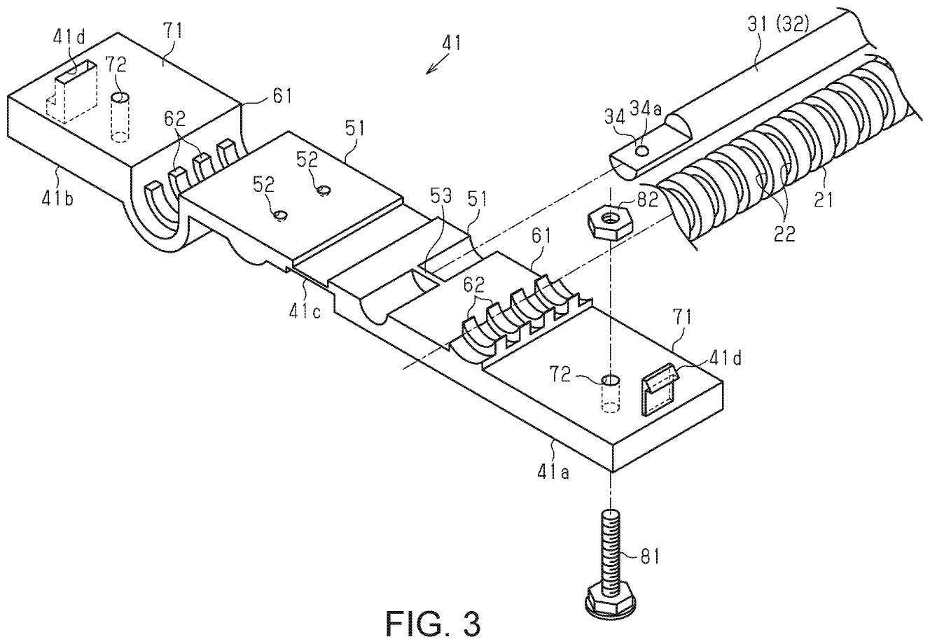

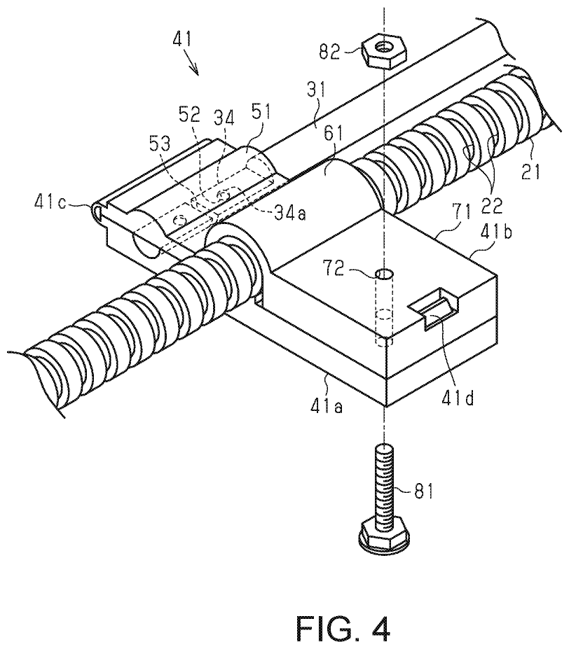

As shown in FIGS. 3 and 4, in the fixing member 41, the support portion 51 that supports the first route-regulating member 32 has an annular structure. The annular structure has a non-circular inner circumferential shape that fits to an end portion 34, which serves as a supported portion, of the first route-regulating member 32 and thereby restricts the first route-regulating member 32 from rotating about its axis.

In other words, in the first route-regulating member 32, the end portion 34 that is supported by the support portion 51 of the fixing member 41 has a non-circular outer circumferential shape that fits into the annular structure of the support portion 51 and thereby causes the first route-regulating member 32 to be restricted from rotating about its axis. The end portion 34 of the first route-regulating member 32 has a semicircular outer circumferential shape, for example. The annular structure of the support portion 51 of the fixing member 41 has an inner circumferential shape that corresponds to the shape of the end portion 34 of the first route-regulating member 32 and that is semicircular, for example.

A locking projection 34a is provided on the end portion 34 of the first route-regulating member 32. The first route-regulating member 32 is restricted from moving in the axial direction relative to the support portion 51, by the locking projection 34a locking into the support portion 51 of the fixing member 41. In other words, the support portion 51 of the fixing member 41 has a locking recess 52 for locking to the locking projection 34a of the first route-regulating member 32, and restricts the first route-regulating member 32 from moving in the axial direction.

The support portion 51 of the fixing member 41 has a wall portion 53 against which an end surface of the first route-regulating member 32 in the axial direction can abut.

Next, the attachment portion 61 and the fixed portion 71 of the fixing member 41 will be described.

A middle portion of the exterior material 21 in the longitudinal axis direction is attached to the attachment portion 61 of the fixing member 41. The attachment portion 61 has an annular structure that matches the outer circumferential shape of the exterior material 21. An inner circumferential surface of the annular structure of the attachment portion 61 has an attachment projection 62 that fits into an annular recess 22 in the outer circumferential surface of the exterior material 21 (corrugated tube). In the present embodiment, the inner circumferential surface of the annular structure of the attachment portion 61 has a plurality of attachment projections 62 so as to fit into a plurality of annular recesses 22 that are arranged in the longitudinal axis direction of the exterior material 21, but the inner circumferential surface of the annular structure of the attachment portion 61 may also have only one attachment projection 62.

The fixed portion 71 of the fixing member 41 has a through hole 72 into which a bolt 81 is to be inserted. The fixing member 41 can be fixed to the vehicle 90 using the bolt 81 and a nut 82. The bolt 81 may be welded to the vehicle 90 in advance. Note that the fixed portion 71 of the fixing member 41 may be, for example, a clip for locking into an attachment hole provided in the vehicle 90.

Next, details of the structure of the fixing member 41 of the present embodiment will be described.

As shown in FIGS. 3 and 4, the fixing member 41 has a first main body portion 41a and a second main body portion 41b, as well as a connecting portion 41c that connects the first main body portion 41a and the second main body portion 41b to each other so that the first main body portion 41a and the second main body portion 41b can rotate relative to each other. The connecting portion 41c functions as a hinge, and thus, the first main body portion 41a and the second main body portion 41b of the fixing member 41 are configured to be able to be openably closed from an opened position shown in FIG. 3 to a closed position shown in FIG. 4. When the fixing member 41 is in the closed position, the first main body portion 41a and the second main body portion 41b are arranged superposed one on top of the other, and the above-described support portion 51, attachment portion 61, and fixed portion 71 are formed. In the fixing member 41 that is in the closed position, the support portion 51, the attachment portion 61, and the fixed portion 71 are sequentially arranged in ascending order of distance from the connecting portion 41c.

The fixing member 41 has a locking mechanism 41d that maintains the fixing member 41 in the closed position. The locking mechanism 41d of the present embodiment is constituted by a locking claw provided on the first main body portion 41a and a locking hole formed in the second main body portion 41b. Note that the locking mechanism 41d may also have a configuration in which a locking hole is provided in the first main body portion 41a and a locking claw is provided in the second main body portion 41b, or the locking mechanism 41d may be changed to another well-known locking mechanism other than a locking claw and a locking hole.

As shown in FIG. 1, with respect to the second straight route R2, a fixing member 41 for fixing a middle portion of the second route-regulating member 33 to the vehicle is used. A member similar to the fixing member 41 shown in FIGS. 3 and 4 except that the wall portion 53 is omitted can be used as this fixing member 41.

Next, the connecting member 42 will be described.

As shown in FIG. 1, the wire harness 10 includes two connecting members 42 that connect the first route-regulating member 32 to the exterior material 21 on the first straight route R1. One of the two connecting members 42 that are used on the first straight route R1 supports a middle portion of the first route-regulating member 32, and the other connecting member supports one end portion of the first route-regulating member 32.

With respect to the second straight route R2, two connecting members 42 are used to connect the second route-regulating member 33 to the exterior material 21. The two connecting members 42 that are used on the second straight route R2 support respective ends of the opposite ends of the second route-regulating member 33.

Unlike the fixing members 41, the connecting members 42 are not fixed to the vehicle 90.

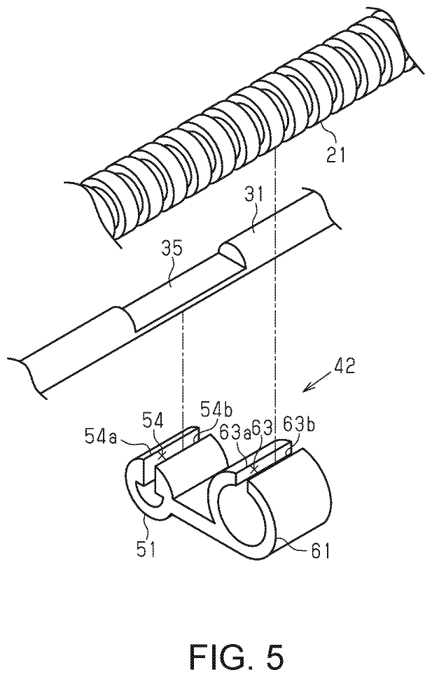

As shown in FIG. 5, the support portion 51 of the connecting member 42 that supports the route-regulating member 31 has an annular structure that matches the outer circumferential shape of the route-regulating member 31. The annular structure has a non-circular inner circumferential shape that fits to a supported portion 35 of the route-regulating member 31 and thereby restricts the route-regulating member 31 from rotating about its axis.

In other words, in the route-regulating member 31, the supported portion 35 that is supported by the support portion 51 of the connecting member 42 has a non-circular outer circumferential shape that fits into the annular structure of the support portion 51 and thereby causes the route-regulating member 31 to be restricted from rotating about its axis. The supported portion 35 of the route-regulating member 31 has a semicircular outer circumferential shape, for example. The annular structure of the support portion 51 of the connecting member 42 has an inner circumferential shape that corresponds to the shape of the supported portion 35 of the route-regulating member 31 and that is semicircular, for example.

The annular structure of the support portion 51 of the connecting member 42 has an insertion portion 54 through which the route-regulating member 31 can be inserted along the radial direction of the annular structure. That is to say, the annular structure of the support portion 51 is a discontinuous annular structure and has a first end portion 54a and a second end portion 54b that opposes the first end portion 54a while being spaced apart from the first end portion 54a. The annular structure of the support portion 51 is configured to be deformable between a first form that allows the route-regulating member 31 to be inserted from the insertion portion 54 between the first end portion 54a and the second end portion 54b and a second form that allows the route-regulating member 31 inserted from the inserted insertion portion 54 to be supported. That is to say, the annular structure of the support portion 51 is elastically deformable so that the distance (width of the insertion portion 54) between the first end portion 54a and the second end portion 54b can be increased. Note that the support portion 51 of the connecting member 42 may be configured such that when its annular structure is in the second form, the first end portion 54a and the second end portion 54b are in contact with each other.

As shown in FIG. 5, a middle portion of the exterior material 21 in the longitudinal axis direction is attached to the attachment portion 61 of the connecting member 42. The attachment portion 61 has an annular structure that matches the outer circumferential shape of the exterior material 21. The annular structure of the attachment portion 61 has an insertion portion 63 through which the exterior material 21 can be inserted along the radial direction of the annular structure. That is to say, the annular structure of the attachment portion 61 is a discontinuous annular structure and has a first end portion 63a and a second end portion 63b that opposes the first end portion 63a while being spaced apart from the first end portion 63a. The annular structure of the attachment portion 61 is configured to be deformable from a first form that allows the exterior material 21 to be inserted from the insertion portion 63 between the first end portion 63a and the second end portion 63b and a second form that allows the exterior material 21 inserted from the insertion portion 63 to be supported. That is to say, the annular structure of the attachment portion 61 is elastically deformable so that the distance (width of the insertion portion 63) between the first end portion 63a and the second end portion 63b can be increased. Note that the attachment portion 61 of the connecting member 42 may be configured such that when its annular structure is in the second form, the first end portion 63a and the second end portion 63b are in contact with each other.

The fixing members 41 and the connecting members 42 used on the first straight route R1 and the second straight route R2, which have been described in detail above, can be made of a metal material or a resin material. Preferably, the fixing members 41 and the connecting members 42 are made of a resin material in light of weight reduction, for example. Examples of the resin material include polyolefins, polyamides, polyesters, ABS resins, and the like.

### Attachment Member 43

As described above, the wire harness 10 further includes the attachment member 43 for attaching a portion of the exterior material 21 that is located at a position corresponding to the intermediate route R3 to the vehicle 90. Note that the intermediate route R3 of the present embodiment includes, in addition to the curved routes RC where the exterior material 21 is curved, a straight route where the exterior material 21 extends in a straight line. A member that has the same configuration as the fixing member 41 shown in FIG. 3 and described above can be used as the attachment member 43. That is to say, in the case where the fixing member 41 is used as the attachment member 43, the exterior material 21 can be attached to the vehicle 90 using the attachment portion 61 and the fixed portion 71 of the fixing member 41, without using the support portion 51 thereof.

### Production Method

Next, an example of a method for producing the wire harness 10 will be described.

With the fixing member 41 of the present embodiment, when closing the fixing member 41 from the opened position shown in FIG. 3 to the closed position shown in FIG. 4, it is possible to make the first route-regulating member 32 be supported by the support portion 51 and attach the exterior material 21 to the attachment portion 61. The same applies to the fixing member 41 for fixing the second route-regulating member 33 to the vehicle 90.

In the connecting member 42 shown in FIG. 5, the support portion 51 and the attachment portion 61 have the respective insertion portions 54 and 63. Therefore, for example, even after the end portion 34 of the first route-regulating member 32 is made to be supported by the support portion 51 of the fixing member 41, it is possible to make the middle portion of the first route-regulating member 32 be supported by the connecting member 42. Moreover, even after the exterior material 21 is attached to the attachment portion 61 of the fixing member 41, it is also possible to attach the exterior material 21 to the attachment portion 61 of the connecting member 42 by inserting the exterior material 21 from the insertion portion 63 along the radial direction of the attachment portion 61 of the connecting member 42.

Then, the attachment member 43 is attached to the portion of the exterior material 21 that is located at a position corresponding to the intermediate route R3, and thus, a wire harness 10 is obtained. Note that the wire 11 may be arranged inside the exterior material 21 either before or after the exterior material 21 is attached to the fixing member 41 and the connecting member 42.

Next, the effects of the present embodiment will be described.

(1) The wire harness 10 includes the wire 11, the exterior material 21, the route-regulating member 31, the fixing member 41, and the connecting member 42. The route-regulating member 31 of the wire harness 10 is constituted by the first route-regulating member 32 that regulates the first straight route R1 and the second route-regulating member 33 that regulates the second straight route R2. The intermediate route R3 between the first straight route R1 and the second straight route R2 includes the curved route RC that is not regulated by the route-regulating member 31.

With this configuration, since the intermediate route R3 includes the curved route RC that is not regulated by the route-regulating member 31, a route-regulating member that has a curved portion can be omitted. Accordingly, the overall shape of the route-regulating member 31 that regulates the route of the wire 11 covered by the exterior material 21 can be simplified.

(2) The first route-regulating member 32 is fixed to the vehicle 90 using the fixing member 41 at only one end portion 34 of the opposite end portions of the first route-regulating member 32. In this case, time and effort needed for an operation of fixing the first route-regulating member 32 to the vehicle 90 can be reduced.

(3) The second route-regulating member 33 is fixed to the vehicle 90 only at a middle portion of the second route-regulating member 33. In this case, time and effort needed for an operation of fixing the second route-regulating member 33 to the vehicle 90 can be reduced.

(4) The wire harness 10 further includes the attachment member 43 for attaching, to the vehicle 90, a portion of the exterior material 21 that is located at a position corresponding to the intermediate route R3. In this case, the portion of the exterior material 21 that is located at a position corresponding to the intermediate route R3 can be favorably arranged.

(5) A member is used in common for the fixing member 41 and the attachment member 43 of the wire harness 10. That is to say, the attachment member 43 has the same configuration as the fixing member 41. In this case, the number of types of components can be reduced.

(6) The wire harness 10 includes a plurality of connecting members 42 that connect the first route-regulating member 32 to the exterior material 21 and are not to be fixed to the vehicle 90, and a plurality of connecting members 42 that connect the second route-regulating member 33 to the exterior material 21 and are not to be fixed to the vehicle 90.

In this case, displacement of the exterior material 21 from the first straight route R1 and the second straight route R2 can be favorably suppressed.

The foregoing embodiment may be modified and configured as follows.
The fixing member 41 has the attachment portion 61 to which the exterior material 21 is attached, but this attachment portion 61 can also be omitted. That is to say, although the fixing member 41 for fixing the route-regulating member 31 to the vehicle 90 also has the function of a connecting member for connecting the route-regulating member 31 to the exterior material 21, the function of the connecting member may be omitted. In this case, it is preferable that a connecting member is provided near the fixing member.
The fixing member 41 is not limited to the configuration shown in FIGS. 3 and 4, and a well-known configuration may be adopted as the fixing member 41. The shape of the route-regulating member 31 may also be changed so as to suit the adopted configuration.
The position at which the route-regulating member 31 is supported by the fixing member 41 and the number of fixing members 41 may also be changed. For example, the number of fixing members 41 used to fix the first route-regulating member 32 to the vehicle 90 may be two or more. Also, the number of fixing members 41 used to fix the second route-regulating member 33 to the vehicle 90 may be two or more.
A well-known configuration (e.g., pressure-sensitive adhesive tape, a cable tie, or the like) that can perform the function of connecting the route-regulating member 31 to the exterior material 21 may be adopted as the connecting member 42.
The position at which the route-regulating member 31 is supported by the connecting member 42 and the number of connecting members 42 may also be changed. For example, the number of connecting members 42 used to connect the first route-regulating member 32 to the exterior material 21 may be one, or three or more. Also, the number of connecting members 42 used to connect the second route-regulating member 33 to the exterior material 21 may be one, or three or more.
In the foregoing embodiment, a member is used in common for the fixing member 41 and the attachment member 43, but a member with a configuration in which the support portion 51 is omitted from the fixing member 41 may also be used as the attachment member 43.
The attachment member 43 may be omitted from the intermediate route R3.
The wire harness 10 can also be configured to include three or more route-regulating members that separately regulate different straight routes.
The route-regulating member 31 of the wire harness 10 may also include a route-regulating member that has a curved portion, in addition to the first route-regulating member 32 and the second route-regulating member 33. In this case, the number of route-regulating members that have a curved portion can be reduced because the intermediate route R3 includes the curved route RC that is not regulated by the route-regulating member 31. Accordingly, the overall shape of the route-regulating member 31 that regulates the route of the wire 11 covered by the exterior material 21 can be simplified.
The wire 11 of the wire harness 10 may also be a low-voltage wire, and the portions electrically connected by the wire harness 10 can also be changed as appropriate.
Constituent elements of the above-described embodiment and modifications may be combined.

It will be apparent to those skilled in the art that the present disclosure may be embodied in other specific forms without departing from the technical ideas thereof. For example, some of the components described in the embodiment (or one or more variations thereof) may be omitted, or some of the components may be combined. The scope of the disclosure should be defined with reference to the appended claims, along with the full scope of equivalents to which the appended claims are entitled.

1. A wire harness comprising:
a wire;
an exterior material that has flexibility and covers the wire;
a route regulator that has an axis extending along a wiring route of the wire, the axis of the route regulator not coinciding with a longitudinal axis of the exterior material, and the route regulator regulates the wiring route of the wire from outside the exterior material;
a fixing member for fixing the route regulator to a vehicle; and
at least one connector that connects the route regulator to the exterior material, the connector being provided separately from the exterior material and connecting the route regulator to the exterior material such that the route regulator does not come into direct contact with the exterior material,
wherein the wiring route of the wire includes a first straight route, a second straight route, and an intermediate route between the first straight route and the second straight route, the route regulator includes a first route regulator that regulates the first straight route and a second route regulator that regulates the second straight route, and the intermediate route includes a curved route that is not regulated by the route regulator.

2. The wire harness according to claim 1,
wherein at least one route regulator of the first route regulator and the second route regulator is fixed to the vehicle using the fixing member at only one end of opposite ends of the at least one route regulator.

3. The wire harness according to claim 1,
wherein at least one route regulator of the first route regulator and the second route regulator is fixed to the vehicle at only a middle of the at least one route regulator.

4. The wire harness according to claim 1, further comprising:
an attachment for attaching, to the vehicle, a portion of the exterior material that is located at a position corresponding to the intermediate route.

5. The wire harness according to claim 1,
wherein the at least one connector includes:
a plurality of first connectors that connect the first route regulator to the exterior material and are not to be fixed to the vehicle; and
a plurality of second connectors that connect the second route regulator to the exterior material and are not to be fixed to the vehicle.

6. The wire harness according to claim 1,
wherein the route regulator is bar-shaped.
